(19) United States
(12) Patent Application Publication
(10) Pub. No.: US 2008/0228875 A1
(43) Pub. Date: Sep. 18, 2008

(54) Method and system for speed dating

(76) Inventor: Oren Cohen, Holon (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/716,971

(22) Filed: Mar. 13, 2007

(51) Int. Cl. G06F 15/16; G06F 3/00

(52) U.S. Cl. 709/204; 715/751

(57) ABSTRACT

This computer software program provides way for people from all over the world of all ages and sex, to participate in a matchmaking experience over the internet in real time. This application includes a graphical user interface which displays a table containing say, ten people (5 pairs per session). It is based on what is known as “blind dating” that takes place in physical locations around the world and is incorporated into the World Wide Web. However, in this program the participants will only see the person they are chatting with, while the other participants remain anonymous until the completion of the first round comprising of an initial chat. The program will use a dating website profile database accordingly to the users who play the game.

### FIELD OF THE INVENTION

This invention is in the field of dating, that is to say, the introduction of two people where the aim of each one could be to see if the other attracts him or her sufficiently to want a more serious relationship in the future. Alternatively, the aim could be to have a fun time chatting to a variety of people. More particularly, this invention reveals a method of dating using an internet real-time chat facility.

### BACKGROUND OF THE INVENTION

Dating goes back to the beginnings of mankind and needs little introduction here. With the introduction of the computer and internet the concept of dating changed.

This invention pertains to a computer software/program for an online match making game. The software synchronizes with databases by installing it on a main server of the target company, and the program will be used and distributed as a stand alone application on users' hard drive.

In prior art the match making world on the internet uses the conventional methods of chatting (chat programs), viewing (web camera, pictures) and talking (VOIP). The users browse through profiles and pictures and then connect with someone they wish to. It is well known that most of the users search for partners based on their looks. One of the advantages of the invention is that it provides a different match making method based on direct real-time interaction before deciding more contact.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

This invention is a software program that defines a new match-making technique for online users. It is alternate and different experience in dating. It is also a method for those who are looking for a fun chat in an online environment played on the World Wide Web. With this invention the users who use the program, do not know details of and do not see the other participants until the moment they need to chat with them. This is a different experience for the users who might find their mate, and it gives them a chance to get to know somebody, rather than make a judgment based solely on pictures they browse. The program will also give the opportunity for couples who are looking to befriend other couples, or a single person who is looking for a couple and vice versa. The matching game program will use the profiles from a dating website database and randomly pick members to play the game. The rotation among members will take place say, every seven minutes, and when a match occurred the information will be sent out to the users via e-mail, and also stored in their “history”, that is to say, stored in the computer memory in a file designated to that particular member with that identity name and password.

The invention of the match making game will serve the dating community on-line in real time. The audience of the software is all the people who are registered on dating websites, and are looking for something new in their search for a partner, friend, or short/long term relationship. This software will target the audience who would like to participate in a dating program that is a three dimensional application where each session could be for approximately seven minutes.

The software would be installed on a customer server/host and could be synchronized with the database on their existing dating websites.

The dating program will give the dating community another perspective and opportunity to get to know other people in a more interesting way, namely on-line.

The operator of the software coordinates the day to day administration and management of this invention by having a backend console (administrator), and could maintain and manage the configuration, administration, and any other needs from a single interface.

There could be a way for the dating sites to migrate their existing operations to the dating platform of this invention as they keep their users database including user account, password, and any other information.

After the users are registered with the website and downloaded the application, the users will view a table and say ten chairs around it where they “sit”. For example the participant sits in a group of five men in front of five women that were picked by the system from the database, according to their profile. Each participant could operate the program to “turn” the table around and see themselves and the participant with whom they are chatting from any angle, but could not view the other participants with whom they have not yet chatted. This is so that they will not pre-judge the other participants by looks and then decide not to chat with them. This invention encourages the couples to chat first and then make a more informed judgment. The “table” around which the participants sit (that is to say, virtually) will not show the other participants' pictures but instead it could show them as for example, a blurred image.

The participants have say seven minutes to chat with their partner. When say one minute is left they could hear an alert alarm and will get ready to finish. When the time is up, they could have say thirty seconds to decide if they feel there is a match between them. That could be done by throwing a virtual flower on the table. The participants could only see the flower they choose, but not the choice of the person they have been speaking to. The choice for flowers could be in different colors where black could mean “not interested”, and a red flower could mean “interested to chat again”. If the thirty seconds is up and a flower is not put on the table, that could default to “not interested” and show a black flower. After the time is up the participant would see the flower of the other participant chose and a rotation of participants around the “table” would take place. When a black flower is picked two options could show up namely:
1. Do not want any future sitting with the participant.
2. Give the participant a chance in another time.

The rotation could be among the men, so the women would remain seated and the men would rotate as follows. If the men were seated in 1,2,3,4,5 so first rotation is 5,1,2,3,4 then second rotation is 4,5,1,2,3 etc. After the rotations are over and everybody chatted, the first part of the game is over. At this point, on the screen could be a billboard to view the matches.

If a match occurred the software could send the information to each participant so they can stay in touch (such as email, chat user name, and other predetermined information).

Those who have more than one matching partner could get the information relating to all of them.

The option could be also given for like sexes or couples to search for matches.

The minimum number of participants is two and the maximum is not limited.

The present invention herein above conveys the information clearly for the reader to understand the intention of the invention. However, configurations of the system depend on many aspects, including the systems used by hosting servers, hardware, the end users' hardware and browsers.

The present invention is not limited to the graphical user interface described herein. Also, the number of multiple users and span time of chatting is not limited. It is recognized that changes that can occur within the scope of this invention.

The operating program could choose randomly the participants within the potential participants according to criteria pre-selected.

Participants and potential participants could choose to see how many tables are operating and see the basic criteria of those tables, for example, ages, sex or income.

Many pairs of participants could sit at on virtual table and be communicating simultaneously without one pair interfering with the other.

There could be an option, with the agreement of both participants having a “chat”, to allow other participants to view the couple and hear and see their chat. This could be for a limited amount of time. A potential participant could opt to ask to chat with one of a viewed pair if they indicated that they were available for a chat session.

This last feature would have an element of fun for the participants and also be a promotion and marketing feature for the operating company.

The participants could read the information details of the other participants on his/her virtual table, that is to say, the participants with whom he/she will eventually have a chat session. The total time for chatting for all the participants would be fixed, that is to say for example, a table of six participants who make three pairs at any one time where each chat session has been allotted a maximum of five minutes, there would be a total chatting time of seventy-five minutes (15 possible pairs multiplied by 5 minutes). Although the total chatting time were seventy-five minutes, participants can choose to shorten certain sessions and use that time to have longer sessions where both parties choose to chat for longer than the recommended maximum time, in the above example, five minutes. Pairs who wish to chat in this extended time can utilize spare time not utilized by other pairs. There would be indicators to show the time calculations. The extra time over the individual maximum time could only be utilized after some pairs have chatted for shorter than this individual maximum time. Every pair is entitled to chat for the individual maximum time and the total maximum time, in the above example seventy-five minutes, would not be extended.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a flowchart depicting display and graphical user interface to start the game.

FIG. 2 is a flowchart depicting the interaction between the software, the host server, and the user.

Table 1 shows the steps to load the program onto the user's computer.

Table 2 shows the steps to enter the user's name and password.

Table 3 shows some of the features available for user's of this invention.

Table 4 shows some options with the chat and Volp options.

Table 5 shows a selection of accessory buttons available to the user.

Table 6 shows examples of historical information about the user for storage in the computer memory.

Table 7 shows steps to end the session.

FIG. 3 is a schematic depiction of the computer screen of the program of the as seen by the user.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

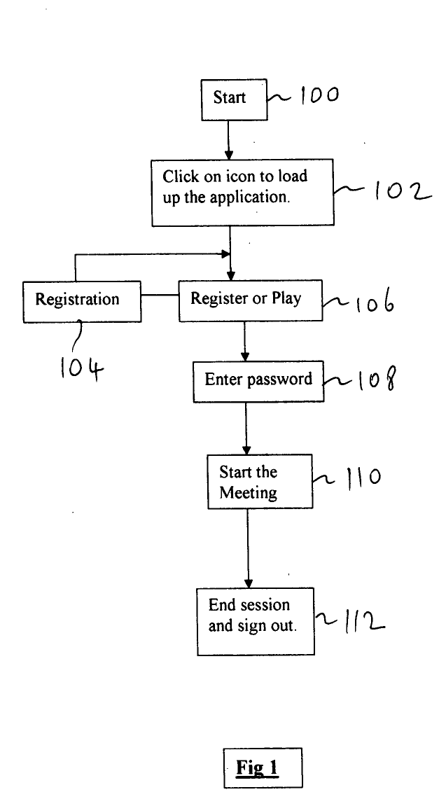

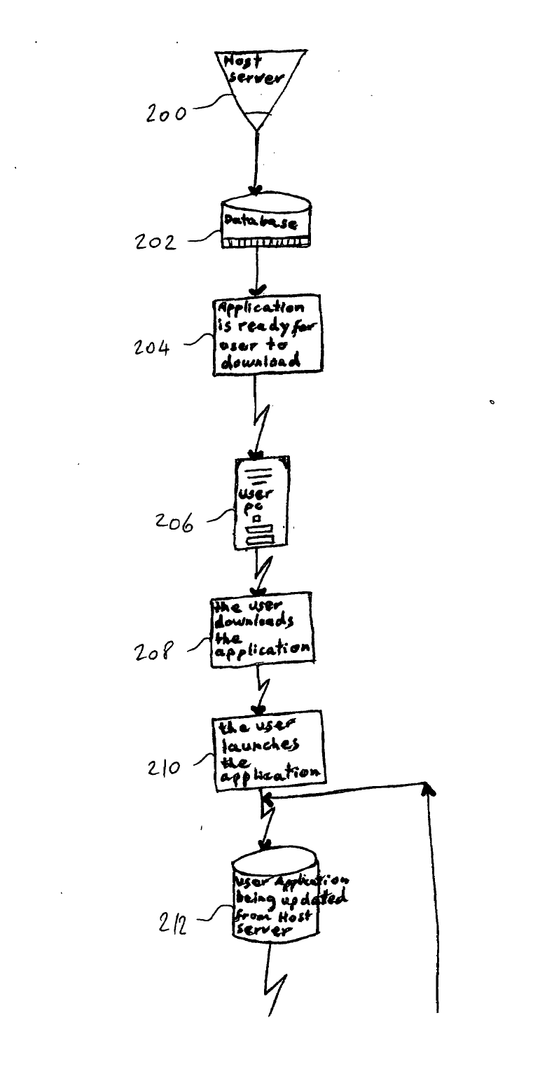

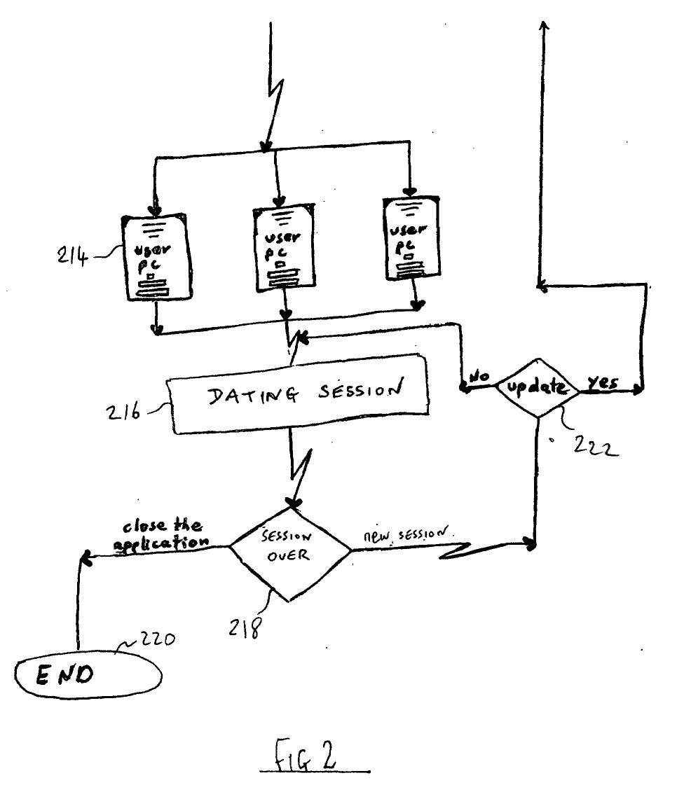

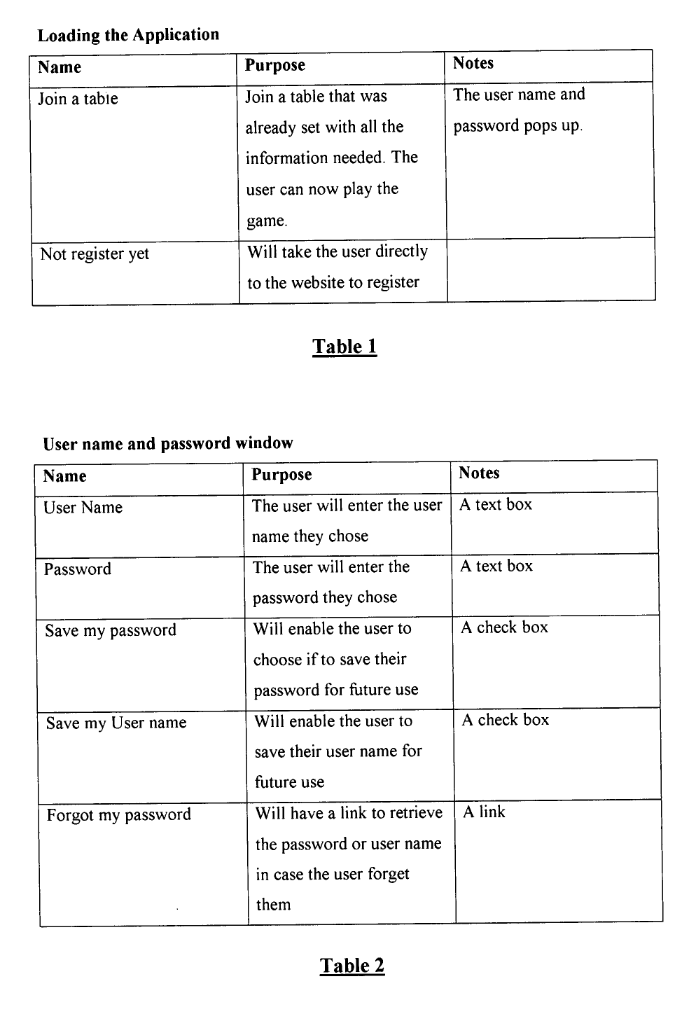

FIG. 1 shows a flowchart of the steps to sign on and start 100 the blind dating process. The connection to the web site can be by searching for the appropriate name or if there is a pre-made icon 102 on the user's computer screen for direct entry to the web site this icon 102 would be clicked on. First time users would then carry out the registration process 104. Those already registered 106 could continued by entering their password 108 and start the process of meeting 110 other people wishing to “play”. At the end of the session the person would sign out 112 or repeat the process.

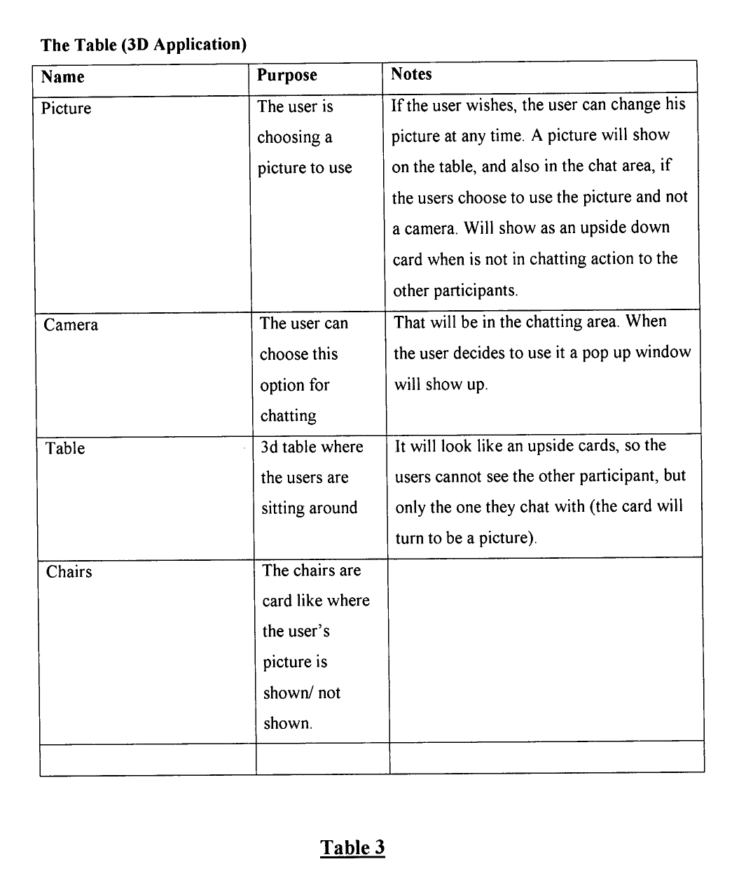

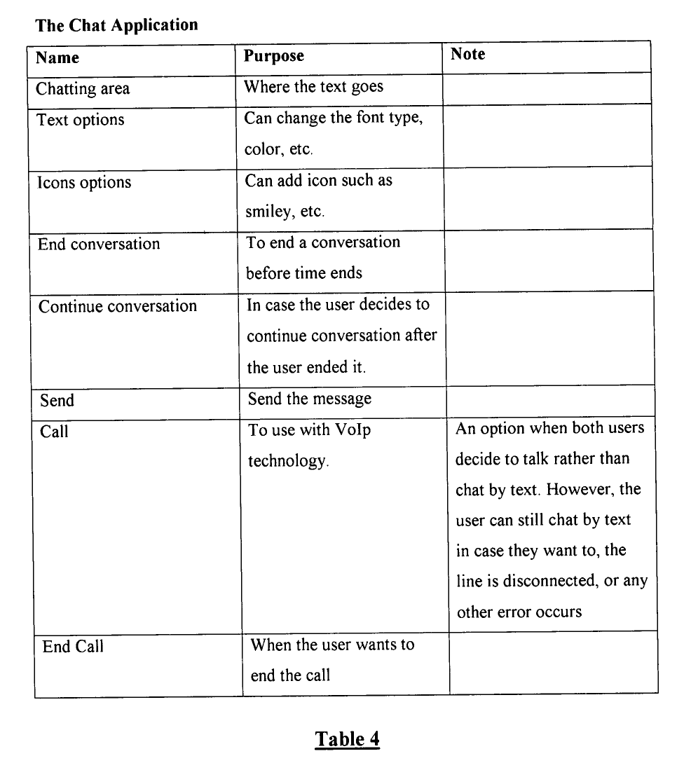

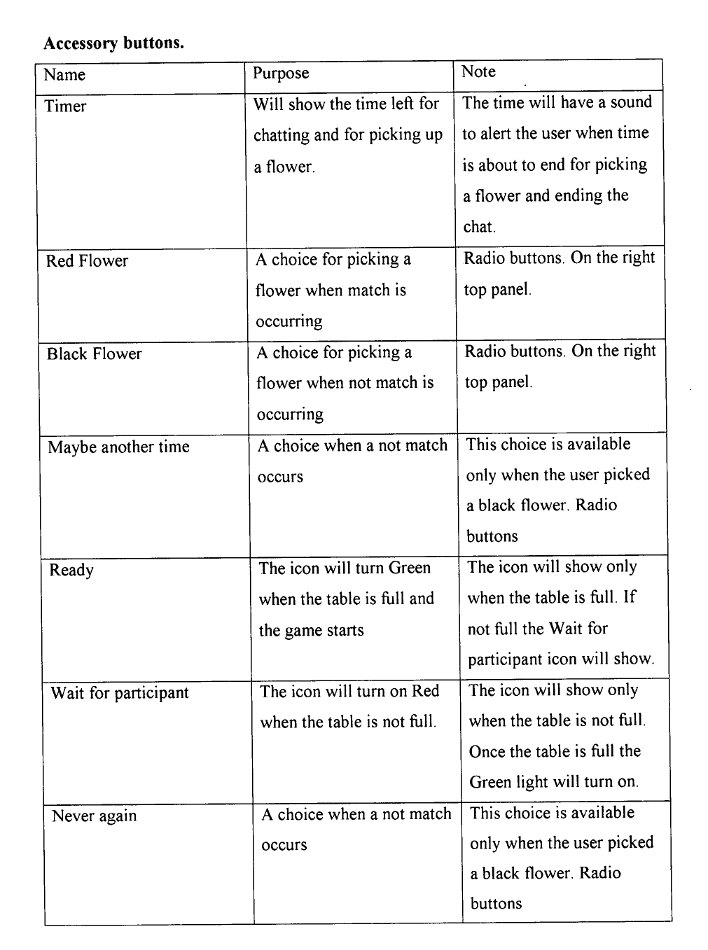

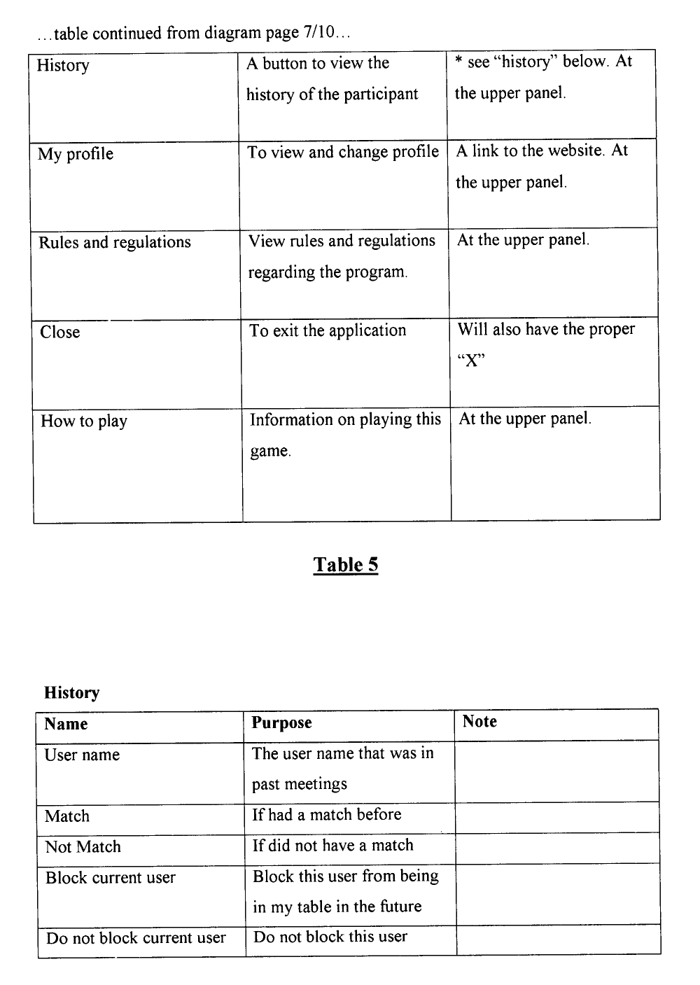

FIG. 2 is a flowchart shows the software of the host server 200 that would contain a database 202 of inter alia all relevant details of registered users including prior matches and rejections established by registered users at previous meetings. When the database 202 is updated the application is ready for a registered user to download 204. The user could connect into the web site via his personal computer 206 and download the application 208. After complying with initial registration procedure, the user opens the application 210. The user application is updated from the host server 212 together with other users who are ready to meet others who are waiting to meet people via their personal computers 214.

The dating session 216 then takes place. When it is over 218 the user has the option to repeat the session or close the application 220. In any event the host server is updated 222 with the results of the completed session.

The detailed explanation of Table 1-Table 7 is contained in the body of each table and no further explanation is required.

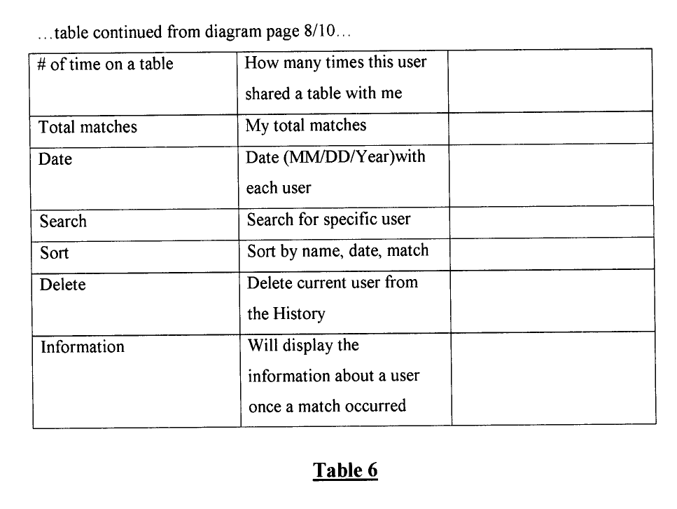

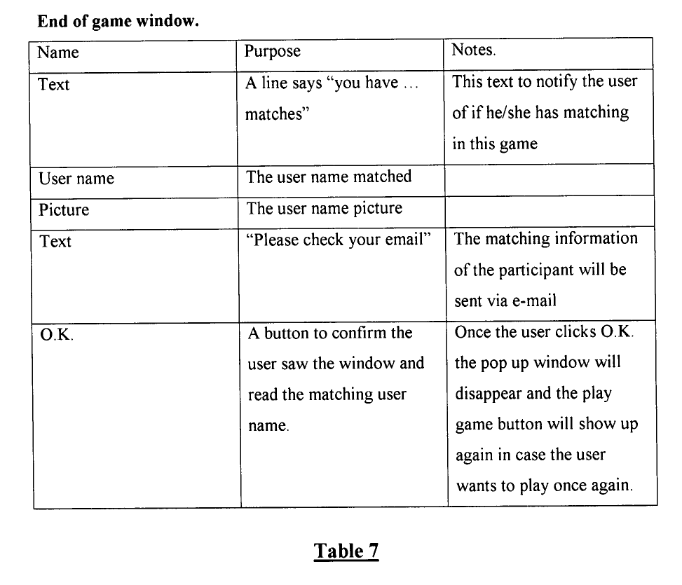

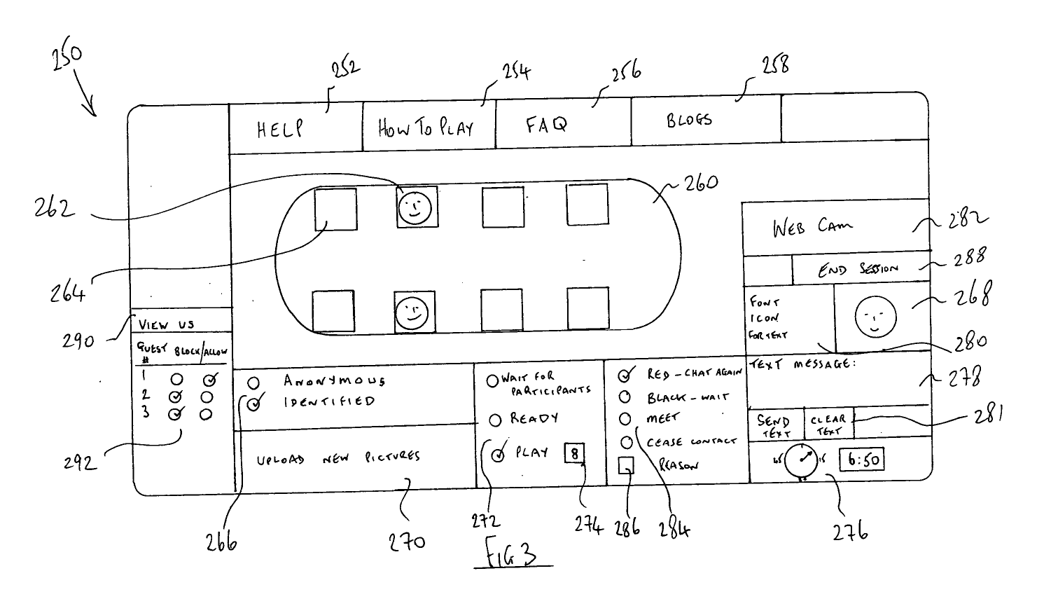

FIG. 3 shows the computer screen 250 with a selection of the features of this invention. The top bar could contain useful tools like for example, a general help guide 252, directions how to play this game 254, frequently asked questions 256, and blogs 258.

The virtual table 260 seats the participants in a particular session. The two people conversing 262 would see each other but not see the others 264 who may be waiting or conversing. A person conversing may wish to remain anonymous and he has the option to do by clicking on the relevant choice button 266. Whether or not the other participant has a web camera to film his face during the conversation, the other participant may display to the person he is chatting to, a digital photograph of himself 268 and may upload new pictures 270 when desired.

There are buttons to click to indicate waiting for more participants, ready to play and when busy playing 272. Also there could be a numerator showing how many participators have indicated willingness to join that group 274.

A timer 276 would indicate how much time is left to chat to that particular participant. If extra time is requested and granted that extra time would be added to the remaining time displayed on the timer 276.

A participant could write and send a text message 278 to other participants with whom he is chatting or thereafter if such details have been exchanged. Buttons 280 to assist such text writing could be used like the font type and size and icons. Also buttons 281 to clear text and send text.

The use of the web camera 282 would display 262 the participant or part of him to the other participant during the chatting period. This display 262 would be at the position of the participant on the table 260. A participant could have displayed on his screen the video of himself so that he will see what the other participant sees.

At the end of a chatting session the participant would have a certain amount of time allotted to give his opinion 284 for example, a desire to chat again with the other participant of the pair or to wait without committal or to request to meet in person or to cease any more contact. In any of these cases the participant could give reasons 286 fro his decision that would be sent to the other participant of the pair in that chat session.

A participant who wished to end the chat with that person could click on the button 288 to do so and wait for the next person in the group to be free to chat.

By agreement between the two participants chatting they can allow others to view the chat session 290 with an option to limit 292 the amount of observers at any one time.

The present invention is not intended to be limited to the embodiments described above, but to encompass any and all embodiments within the scope of the following claims.

What is claimed is:

1. A method and system for blind-dating operated by a software computer program comprising,
a) a data base of past and future participants,
b) a means to register new users to the said program,
c) a means to enable access to the said program by registered users according to a password,
d) a means to select participants for a meeting and a chat around a virtual table,
e) a means to enable a pair of the said selected participants to see only an image of the person they are chatting with and their own image,
f) a means to enable the said pair to speak to one another and to hear one another,
g) a means to enable the said pair to indicate if they are interested or not in further communication,
h) a means, using the said program, to rotate the said participants at the end of a chatting session so different participants chat in pairs,
i) a limited time for each pair to chat,
j) the ability for each participant at the end of a chat session, to indicate if he wishes to communicate again with the other pair in the said chat session.
whereby people can participate in chat sessions for the purpose of getting better acquainted with other people.

2. A method and system for blind-dating as claimed in claim 1 wherein the said chatting pair can agree to allow others to view at least part of the chat session.

3. A method and system for blind-dating as claimed in claim 1 wherein the purpose of the said program is at least one of dating, friendship, meeting, chatting and fun.

4. A method and system for blind-dating as claimed in claim 1 wherein the said participant in a chatting group can see more participants of the said group than the person with whom he is chatting.

5. A method and system for blind-dating as claimed in claim 1 wherein all or a portion of the said communication is optionally by text writing rather than verbal communication.

6. A method and system for blind-dating as claimed in claim 1 wherein the choice of criteria for the other people in the meeting is made by the participator.

7. A method and system for blind-dating as claimed in claim 1 wherein the choice of criteria for the other people in the said group is made by the computer program based on information in the said data base and other information if any, provided by the participator.

8. A method and system for blind-dating operated by a software computer program comprising,
a) a data base of past and future participants,
b) a means to register new users to the said program,
c) a means to enable access to the said program by registered users according to a password,
d) a means to select participants for a meeting and a chat around a virtual table,
e) a means to enable a pair of the said selected participants to see only an image of the person they are chatting with and their own image,
f) a means to enable the said pair to speak to one another and to hear one another,
g) a means to enable the said pair to indicate if they are interested or not in further communication,
h) a means, using the said program, to rotate the said participants at the end of a chatting session so different participants chat in pairs,
i) a limited time for each pair to chat,
j) the ability for each participant at the end of a chat session, to indicate if he wishes to communicate again with the other pair in the said chat session.
k) a means to store information regarding the said meetings and create personal files of the said participants indicating successful and unsuccessful matches and
l) a means to retrieve, analyze and output from the said store of information,
whereby people can participate in chat sessions for the purpose of getting better acquainted with other people.

9. A method and system for blind-dating as claimed in claim 8 wherein the said chatting pair can indicate to allow others to view at least part of the chat session.

10. A method and system for blind-dating as claimed in claim 8 wherein the purpose of the said program is at least one of dating, friendship, meeting, chatting and fun.

11. A method and system for blind-dating as claimed in claim 8 wherein the said participant in a chatting group can see more participants of the said group than the person with whom he is chatting.

12. A method and system for blind-dating as claimed in claim 8 wherein all or a portion of the said communication is optionally by text writing rather than verbal communication.

13. A method and system for blind-dating as claimed in claim 8 wherein the choice of criteria for the other people in the meeting is made by the participator.

14. A method and system for blind-dating as claimed in claim 8 wherein the choice of criteria for the other people in the said group is made by the computer program based on information in the said data base and other information if any, provided by the participator.
